(19) United States
(12) Patent Application Publication
(10) Pub. No.: US 2020/0171602 A1
(43) Pub. Date: Jun. 4, 2020

(54) LASER ANNEALING DEVICE AND LASER ANNEALING METHOD

(71) Applicant: V Technology Co., Ltd., Yokohama (JP)

(72) Inventor: Michinobu Mizumura, Yokohama (JP)

(21) Appl. No.: 16/787,488

(22) Filed: Feb. 11, 2020

Related U.S. Application Data
(63) Continuation of application No. PCT/JP2018/028149, filed on Jul. 26, 2018.

(30) Foreign Application Priority Data
Aug. 31, 2017 (JP) 2017-166901

(51) Int. Cl. B23K 26/06; G02B 27/09; B23K 26/066

(52) U.S. Cl. CPC B23K 26/0648; G02B 27/0961; G02B 27/0988; G02B 27/0927; B23K 26/066

(57) ABSTRACT

A laser annealing device includes a light source that generates laser light; a fly-eye lens that makes an intensity distribution of the laser light uniform; a projection mask that masks the laser light having passed through the fly-eye lens; and a projection lens that forms a laser beam that irradiates a predetermined range of a substrate with the laser light having passed through the projection mask, wherein an arrangement orientation of the fly-eye lens is rotated by a predetermined angle with respect to an arrangement of a mask pattern of the projection mask to reduce moire that may be generated by interference fringes generated when the laser light passes through the projection mask passing through the fly-eye lens.

### TECHNICAL FIELD

This disclosure relates to a laser annealing device that anneals a substrate with a laser, and a method thereof.

### BACKGROUND

Laser annealing techniques are known that convert amorphous silicon of a silicon substrate into polysilicon. Laser annealing is generally a technique that irradiates an amorphous silicon film with a laser to heat the amorphous silicon film at a low temperature and converts the amorphous silicon film into polysilicon and is used to produce a substrate such as a liquid crystal panel. Laser annealing includes a line beam method and a microlens array method. Japanese Unexamined Patent Application Publication No. 2012-182348 discloses an example of such a laser annealing technique.

However, in a laser annealing device, it is necessary to install a homogenizing means such as a fly-eye lens to make an intensity distribution of laser light emitted from a light source as uniform as possible. Also, at the same time, masking by a projection mask may be performed to limit places at which annealing is performed. However, the laser light having passed through lenses constituting the fly-eye lens may interfere and may generate interference fringes. Additionally, when a period (also, referred to as a pitch) of the interference fringes generated by the fly-eye lens is different from a period of arrangement of openings through which light passes in the projection mask, an intensity peak of the interference fringes may hit a light shielding portion of the projection mask when the laser light in which the interference fringes are generated passes through the projection mask, and a periodic spatial fluctuation (moire) of energy applied to amorphous silicon may occur. Since the occurrence of moire causes a periodic fluctuation in TFT characteristics on a panel and appears as display unevenness in a display as a final product, it is important to reduce the occurrence of moire.

It could therefore be helpful to provide a laser annealing device that is able to reduce occurrence of moire in a laser annealing device using a fly-eye lens and a projection mask, and a method thereof.

### SUMMARY

I thus provide:

A laser annealing device may include a light source that generates laser light, a fly-eye lens that makes an intensity distribution of the laser light uniform, a projection mask that masks the laser light having passed through the fly-eye lens, and a projection lens that forms a laser beam that irradiates a predetermined range of a substrate with the laser light having passed through the projection mask, wherein an arrangement orientation of the fly-eye lens is rotated by a predetermined angle with respect to an arrangement orientation of a mask pattern of the projection mask to reduce moire that may be generated by interference fringes generated when the laser light passes through the projection mask passing through the fly-eye lens.

Also, in the laser annealing device, the projection lens may be a microlens array in which microlenses that project to at least one opening of the projection mask are arranged one-dimensionally or two-dimensionally.

Further, the fly-eye lens may have a rectangular outer shape and may be formed so that the arrangement orientation of the fly-eye lens is inclined by a predetermined angle with respect to one side of the rectangular outer shape.

A laser annealing method may use a laser annealing device, including an irradiation step of emitting laser light from a light source that generates the laser light, a uniformizing step of making an intensity distribution of the laser light uniform by a fly-eye lens, a masking step of masking the laser light having passed through the fly-eye lens with a projection mask, and a forming step of forming a laser beam that irradiates a predetermined area of a substrate with the laser light masked by a projection mask through a projection lens, wherein the laser annealing device is configured so that an arrangement orientation of the fly-eye lens is rotated by a predetermined angle with respect to an arrangement orientation of a mask pattern of the projection mask to reduce moire that may be generated by interference fringes generated when the laser light passes through the projection mask passing through the fly-eye lens.

The laser annealing device can reduce occurrence of moire in a target object even when a fly-eye lens and a projection mask that blocks part of laser light are used.

### BRIEF DESCRIPTION OF THE DRAWINGS

FIG. 1A is a plan view of a laser annealing device, and FIG. 1B is a side view of the laser annealing device.

FIG. 2A is an example of a plan view of a fly-eye lens, FIG. 2B is an example of a side view of the fly-eye lens in a longitudinal direction, FIG. 2C is an example of a side view of the fly-eye lens in an edge direction, and FIG. 2D is an example of a perspective view of the fly-eye lens.

FIG. 3A is a view showing an example of a state in which the fly-eye lens is not rotated, and FIG. 3B is a view showing an example of a state of the fly-eye lens disposed in the laser annealing device.

FIG. 4 is a flowchart showing an operation of the laser annealing device.

FIG. 5A is a graph showing an example of a distribution of total moire when the fly-eye lens is not rotated. FIG. 5B is a graph showing an example of the distribution of total moire when the fly-eye lens is rotated.

FIG. 6 is a view showing an example of the fly-eye lens.

FIG. 7 is a schematic view for explaining a principle of occurrence of moire.

FIG. 8 is a diagram showing a configuration example when a single projection lens is used instead of a microlens array.

### DESCRIPTION OF REFERENCE NUMBERS

100 Laser annealing device

101 Light source (UV pulse laser radiation device)

110 Optical system

111 Cylindrical lens

112 Fly-eye lens

113 Condenser lens

115 Mirror

116 Projection mask

117 Microlens array

200 Panel

201, 202, 203, 204 Laser light

300 Stage

701, 702 Energy distribution

801 Projection lens

### DETAILED DESCRIPTION

My configuration of a representative example of a laser annealing device will be described in detail with reference to the drawings.

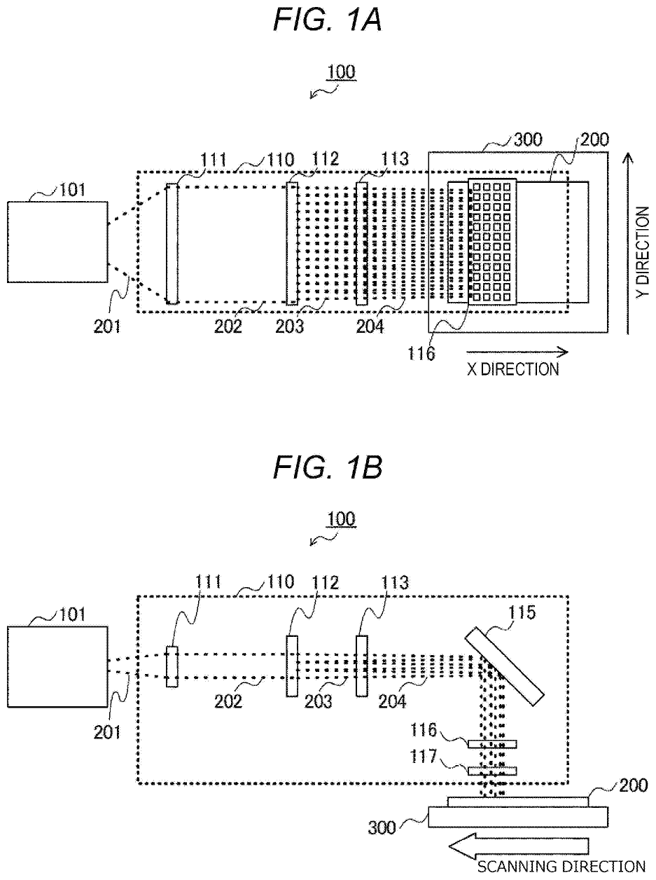

FIG. 1 is a view showing a configuration of a laser annealing device 100. FIG. 1A is a plan view of the laser annealing device 100 when seen from above, and FIG. 1B is a side view of the laser annealing device 100 when seen from the side.

The laser annealing device 100 includes a light source 101 that generates laser light, a fly-eye lens 112 that makes an intensity distribution of the laser light uniform, a projection mask 116 that masks the laser light having passed through the fly-eye lens, a microlens array (a projection lens) 117 that forms a laser beam for irradiating an object to be annealed, that is, a predetermined range of a substrate with the laser light that passed through the projection mask 116. To reduce moire that may be generated by interference fringes generated when the laser light passes through the projection mask passing through the fly-eye lens, an arrangement orientation of the fly-eye lens is rotated by a predetermined angle with respect to an arrangement orientation of a mask pattern of the projection mask. Further, in FIG. 1, the laser annealing device 100 includes a cylindrical lens 111 that concentrates the laser light emitted from the light source 101, and a condenser lens 113 that concentrates the laser light having passed through the fly-eye lens 112.

The light source 101 is a light source that emits laser light 201 for laser annealing and is, for example, a laser oscillator that oscillates a UV pulse laser.

The cylindrical lens 111 concentrates the laser light 201 emitted from the light source 101.

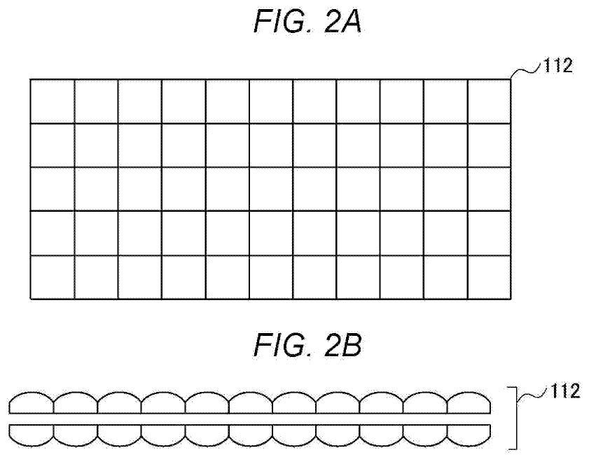

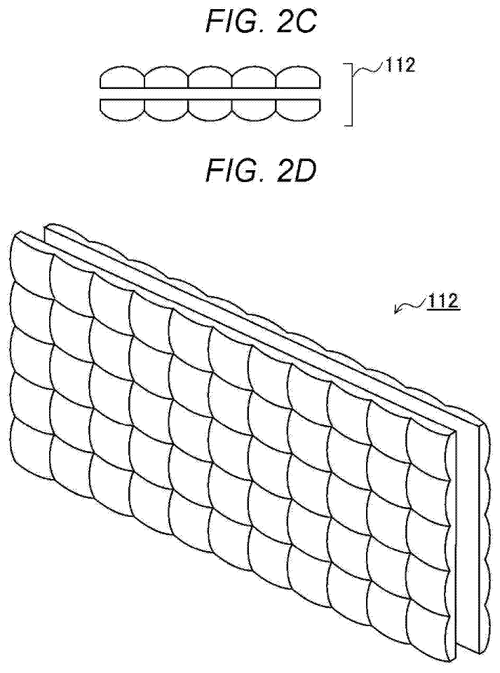

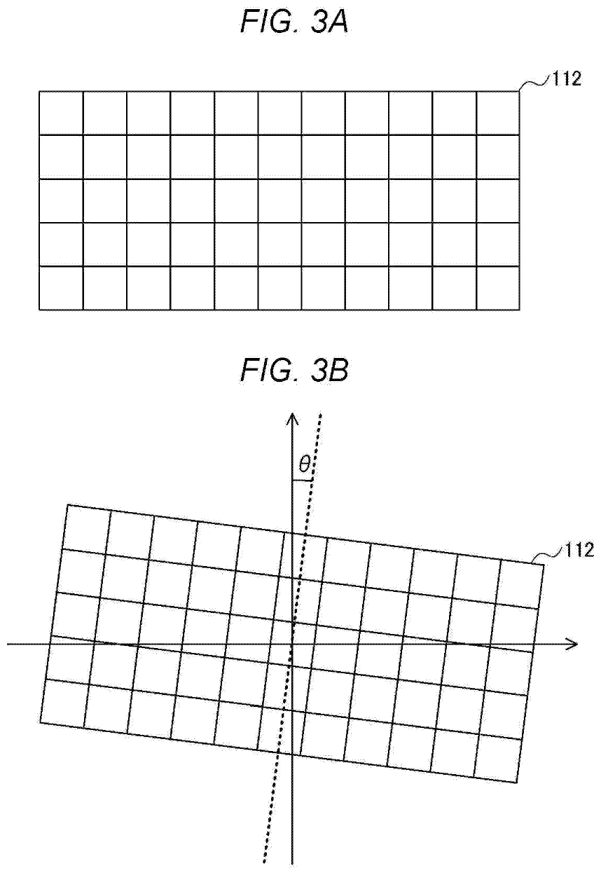

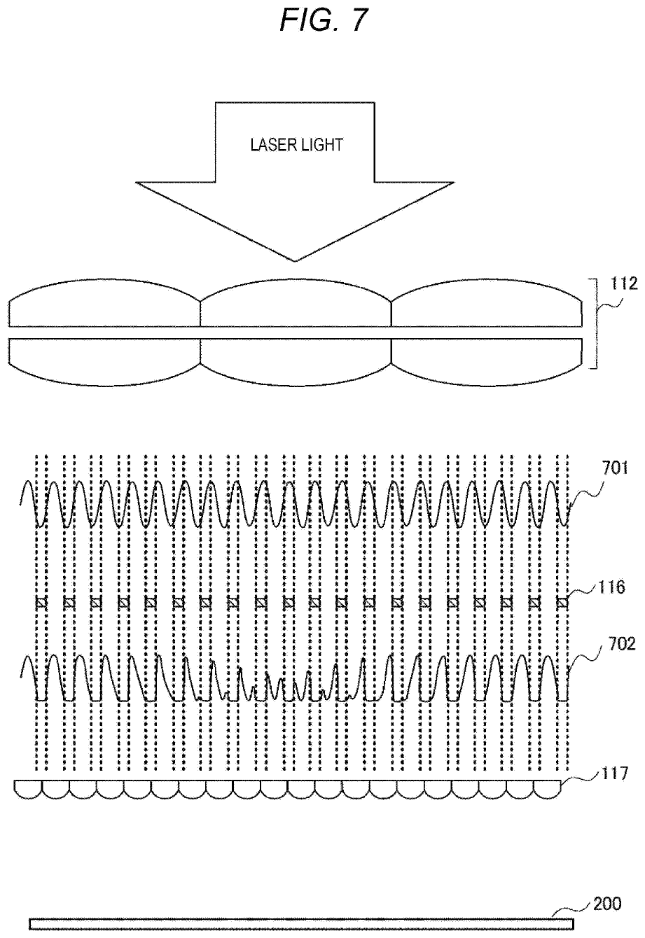

The fly-eye lens 112 makes the intensity distribution of the laser light 202 emitted from the cylindrical lens 111 uniform. FIGS. 2A and 2B are views each showing a configuration example of the fly-eye lens 112. As shown in FIG. 2A, the fly-eye lens 112 includes a plurality of lenses assembled in a matrix array. In FIG. 2A, one rectangle indicates one lens. In addition, each of the plurality of lenses does not necessarily need to have a rectangular shape and may have any shape. As shown in FIG. 3B, the fly-eye lens 112 mounted in the laser annealing device 100 is configured to be mounted in a state in which it is rotated by a predetermined angle θ with respect to a projection mask pattern. That is, the arrangement orientation of the fly-eye lens 112 is inclined by a predetermined angle with respect to the projection mask pattern. The fly-eye lens 112 is used in a state in which a fly-eye lens having a convex surface directed to the light source side and a fly-eye lens having a convex surface directed to a side opposite to the light source face each other. In FIGS. 2A to 2D and 7, the fly-eye lens 112 is shown as two sets of lenses, but it may be integrally formed.

The condenser lens 113 condenses laser light 203 having passed through the fly-eye lens 112 and has a substantially uniform intensity distribution.

A mirror 115 is a mirror body that reflects laser light 204 having passed through the condenser lens 113 toward a panel 200 to be irradiated.

The projection mask 116 masks the laser light 204 reflected by the mirror 115. An opening is provided in the projection mask 116 at a position at which the laser light 204 is radiated to an object to be annealed in the laser annealing so that the laser light 204 is radiated therethrough. For example, the projection mask 116 may be configured so that an opening is provided at a necessary portion of a predetermined substrate capable of blocking the laser light 204 and the laser light 204 is transmitted therethrough and may be configured so that a metal such as chromium that blocks or reflects the laser light is disposed at a portion of a transparent substrate that does not transmit the laser light 204. In the projection mask 116, the openings are arranged in a predetermined mask pattern.

The microlens array 117 has a structure in which a plurality of micro lenses are arranged. The microlens array 117 forms a laser beam that concentrates the laser light having passed through the projection mask 116 and irradiates the panel 200 to be irradiated.

The panel 200 to be irradiated is a substrate on which an amorphous silicon film is formed (coated) and mounted on a stage 300. The panel 200 may be formed of a glass material or a resin material. Further, the panel 200 is not limited to these materials and may be formed of any material.

The stage 300 is a mounting table on which the panel 200 to be laser-annealed is mounted. The stage 300 is driven by a driving device (not shown). Thus, the panel 200 is moved, the laser light passes through the projection mask 116, and a surface of the panel 200 is converted into polysilicon only at a position irradiated with each of the laser beams formed by the microlens array 117. In an example of FIG. 1B, the stage 300 moves toward the light source 101. A movement direction may be referred to as a scanning direction.

Further, the cylindrical lens 111, the fly-eye lens 112, the condenser lens 113, the mirror 115, the projection mask 116, and the microlens array 117 together are referred to as an optical system 110.

The reason why laser annealing is performed using the laser annealing device 100 configured by rotating the fly-eye lens 112 by the predetermined angle θ with respect to the projection mask pattern will be described.

First, moire formed on the panel 200 when laser annealing is performed without rotating the fly-eye lens 112 by the predetermined angle θ will be described with reference to FIG. FIG. 7 is a schematic view explaining a principle of occurrence of moire. FIG. 7 is merely a schematic view, and a relationship between the various lenses, the projection mask, and an energy distribution (a period and an intensity) shown in FIG. 7 may be different from that in FIG. 7.

Although the laser light 203 having passed through the fly-eye lens 112 is configured so that the intensity distribution is as uniform as possible, the laser light has, for example, variation as shown by an energy distribution 701 in FIG. 7 due to the laser light beams that have passed through the microlenses interfering with each other. The energy distribution 701 shown in FIG. 7 is merely an example, and an energy distribution 701 different from that in FIG. 7 may be used.

The laser light 203 having such an energy distribution having the variation passes through the condenser lens 113, passes through the projection mask 116, and thus the panel 200 is annealed by the laser light having the variation shown in an energy distribution 702 (diffraction due to passing through the projection mask 116 or the energy distribution shown in the drawing due to passing through the microlens array 117 are not). At this time, when the laser light having the interference fringes generated by passing through the fly-eye lens 112 passes through the projection mask 116, interference fringes and moire are generated in a spatial distribution of irradiation energy. Moire appears when there is a difference between a pitch (a period) of the interference fringes generated by the interference of the laser light having passed through the fly-eye lens 112 and a pitch (a period) of the openings of the projection mask 116 and occurs with a period different from both the period of the interference fringes and the pitch (the period) of the arrangement of the openings. The energy distribution 702 shown in FIG. 7 is merely an example and may be an energy distribution 702 different from that in FIG. 7.

The occurrence of interference and moire causes periodic fluctuations in TFT characteristics on a panel and appears as display unevenness in a display as a final product. Since the interference and moire occur periodically, regions in which performance of a transistor is reduced also occur periodically in the panel, which also serves as a factor causing display unevenness in the display.

Therefore, in the laser annealing device 100, the occurrence of interference and moire is reduced by rotating the fly-eye lens 112 by the predetermined angle θ. Hereinafter, a specific description will be given.

As described above, FIGS. 2A to 2D show an example of the fly-eye lens 112. FIG. 2A is a plan view of the fly-eye lens 112, FIG. 2B is a side view of the fly-eye lens 112 seen in a longitudinal direction, FIG. 2C is a side view of the fly-eye lens 112 seen in an edge direction, and FIG. 2D is a perspective view of the fly-eye lens 112. Also, FIGS. 3A and 3B are drawings explaining the arrangement orientation of the fly-eye lenses 112. FIG. 3A shows an example in which the fly-eye lens 112 is placed so that the arrangement orientation of a single lens follows a horizontal direction and a vertical direction of the laser annealing device. FIG. 3B shows an example in which the fly-eye lens 112 is placed so that one of the vertical and horizontal arrangement orientations of the single lens is rotated by the predetermined angle θ (for example, 1 degree). That is, the predetermined angle θ is between an irradiation area and the projection mask.

As shown in FIGS. 2A and 2B, the fly-eye lens 112 is a lens body in which single lenses are arranged vertically and horizontally. Normally, as shown in FIG. 3A, the fly-eye lens is mounted so that the arrangement orientations of the single lenses follow the horizontal direction and the vertical direction of the projection mask (so that, when it is assumed that the horizontal arrangement orientation of the single lenses is a p direction and the other vertical arrangement orientation is a q direction, the p direction is the horizontal direction and the q direction is the vertical direction). On the other hand, in the laser annealing device 100 as shown in FIG. 3B, the fly-eye lenses have to be disposed so that one of the vertical and horizontal arrangement orientations of the single lenses is rotated by the predetermined angle θ (for example, 1 degree). In addition, the predetermined angle θ is not limited to 1 degree and may be set to any degree. As described later, an appropriate angle may be calculated as the predetermined angle θ. Accordingly, a shift can be generated between a direction in which the interference fringes generated by the fly-eye lens 112 is generated and a direction in which the openings of the projection mask are arranged and, as a result, the occurrence of interference and moire can be reduced.

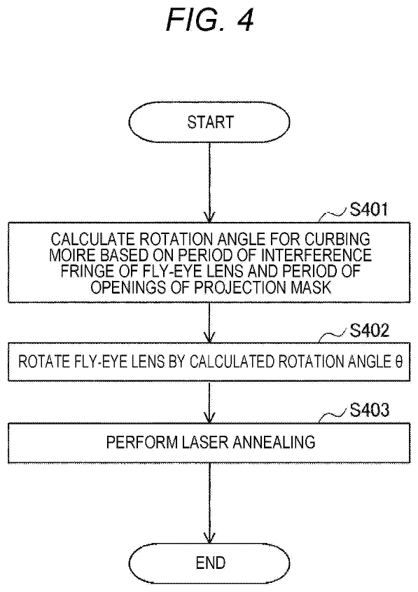

Now, operation of annealing by the laser annealing device 100 will be described. FIG. 4 is a flowchart showing an example of the operation.

First, an operator inputs to a simulator conditions of the light source 101 and the optical system, in particular, the period of the interference fringes formed differently according to the fly-eye lens 112 and the period of the openings (portions through which the laser light passes) in the projection mask 116 to a simulator and calculates a rotation angle θ of the fly-eye lens 112 on the panel 200 to reduce the interference and moire that may occur when the annealing is performed in a state in which the fly-eye lens 112 is not rotated (Step S401). The conditions of the light source 101 and the optical system refer to a laser wavelength oscillated from the light source 101 and characteristics of the fly-eye lens forming the optical system. Also, although the angle that reduces the occurrence of moire is calculated by the simulator, the angle at which interference and moire do not easily occur may be identified by actually rotating the fly-eye lens 112 by various angles and performing the annealing.

The laser annealing device 100 rotates the fly-eye lens 112 by the calculated rotation angle (Step S402). This rotation may be performed by the laser annealing device 100 being driven by a motor or the like or may be performed by manual setting of the operator.

Then, the operator drives the laser annealing device 100 and radiates the laser from the light source 101. The laser annealing device 100 drives the driving device and performs the laser annealing while moving the stage 300 (Step S403). Although the laser annealing is performed while moving the stage 300 (moving the stage 300 in units of an irradiation range), the laser annealing may be performed all at once in a range in which the panel 200 is to be annealed.

Accordingly, the laser annealing device 100 can provide the panel 200 in which amorphous silicon in which moire is reduced is converted into polysilicon.

In addition, the processing in Step S401 is not an operation of the laser annealing device 100 and is preparation processing for laser annealing and is processing in the simulator other than the laser annealing device 100.

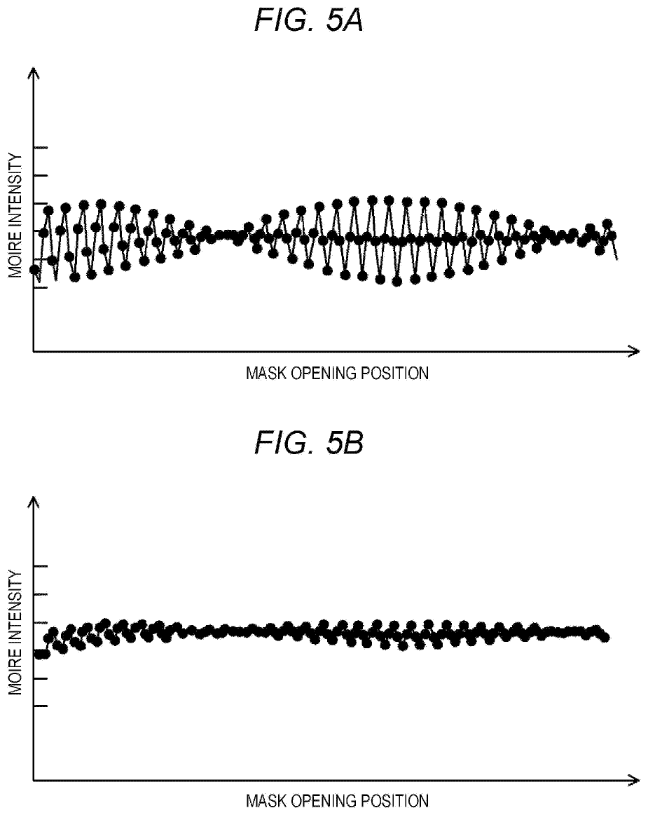

FIGS. 5A and 5B are diagrams showing an example of the intensity distribution of the interference and the moire, FIG. 5A is a graph showing an example of the intensity distribution of the total moire seen in the arrangement orientation (a y direction in FIG. 1) of the openings of the projection mask 116 when the laser light is radiated in a state in which the fly-eye lens is not rotated, and FIG. 5B is a graph showing an example of the intensity distribution of the total moire seen in the arrangement orientation (the y direction in FIG. 1) of the openings of the projection mask 116 when the laser light is radiated in a state in which the fly-eye lens 112 is rotated by the predetermined angle θ. The total moire is a total value of the moire generated by the laser light having passed through each of the openings of the projection mask 116.

As can be understood by comparing FIG. 5A to FIG. 5B, a variation in the intensity distribution of the total moire when the fly-eye lens is not rotated is larger than that when the fly-eye lens 112 is rotated (in other words, a difference between a maximum value and a minimum value of the total moire is large). That is, in FIG. 5A, as a result of the annealing, noticeable interference and moire are generated on the panel 200 as compared to FIG. 5B. Therefore, it is possible to reduce the occurrence of the interference and moire by performing the annealing in the state in which the fly-eye lens 112 is rotated about the irradiation direction of the laser light by the predetermined angle θ.

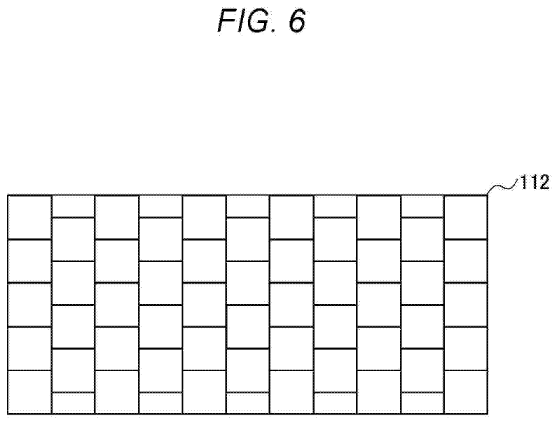

In the above description, although the fly-eye lens 112 is mounted by being rotated by the predetermined angle θ, a fly-eye lens 112 in which the arrangement orientation of the lenses constituting the fly-eye lens 112 is inclined in advance by the predetermined angle θ may be used. FIG. 6 is a view showing an example of the fly-eye lens. As shown in FIG. 6, the state in which the fly-eye lens 112 is inclined by the predetermined angle θ may be formed by shifting the arrangement orientation of the lenses constituting the fly-eye lens 112. The laser annealing device 100 may be configured to mount the fly-eye lens 112, for example, as shown in FIG. 6.

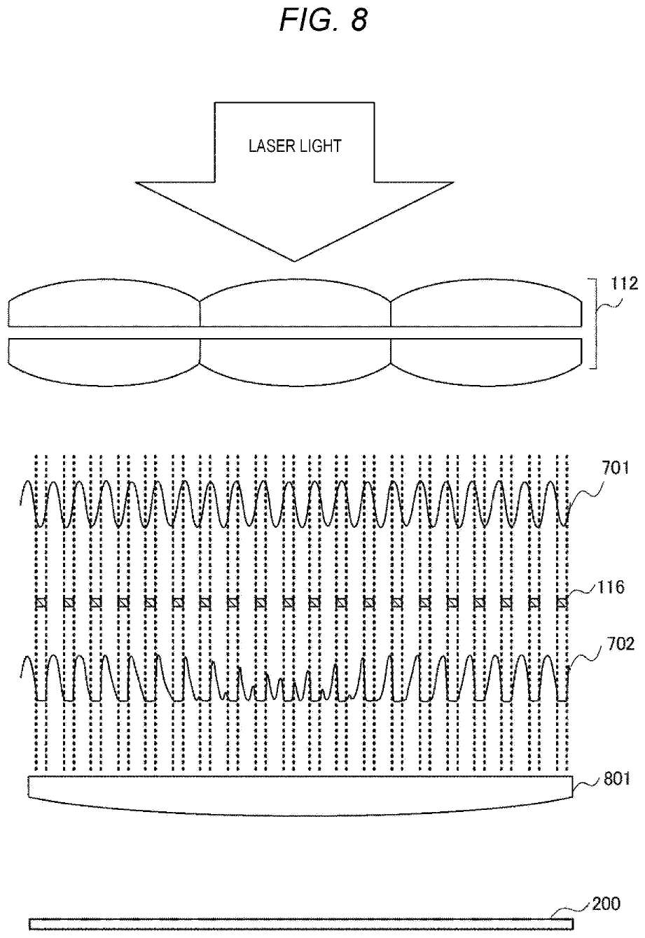

Further, in the example, although an example in which the microlens array 117 is used as the lens that serves as the projection lens has been described, one projection lens may be used. FIG. 8 is a view showing a configuration example when a single projection lens is used instead of the microlens array. That is, as shown in FIG. 8, a configuration in which the laser light having passed through the projection mask 116 is radiated onto the panel 200 by a single projection lens 801 may be adopted. As described above, moire is generated due to the shift between the pitch of the interference fringes by the fly-eye lens and the pitch of the openings of the projection mask, and there is little difference due to the configuration of the projection lens. Therefore, even when one projection lens 801 is used instead of the microlens array 117 as the projection lens, similarly, the occurrence of the moire can be reduced by rotating the fly-eye lens 112 by the predetermined angle θ.

As described above, according to the laser annealing device 100, the interference fringes that may be generated by the laser light having passed through the fly-eye lens can be inclined with respect to the arrangement orientation of the openings of the projection mask 116 by rotating the fly-eye lens 112 by the predetermined angle θ and mounting it in the laser annealing device 100. As a result, since the total value of the energy of the laser light to be shot is applied to the panel 200 and the annealing is performed (the intensity distribution of the total moire can be made uniform), amorphous silicon can be converted into polysilicon by reducing the occurrence of interference and moire. That is, the laser annealing device 100 can make the total amount of energy of the radiated laser light substantially uniform at a position on the panel 200 at which the laser light is to be irradiated.

Although my devices and methods have been described based on the drawings and examples, those skilled in the art can easily make various changes and modifications based on the disclosure. Therefore, variations and modifications are included in the scope of this disclosure. For example, in the laser annealing device 100, it is sufficient that at least the light source 101, the fly-eye lens 112, and the projection mask 116 are used, and the other components of the optical system may be appropriately disposed as needed. Further, in the optical system 110, as long as the laser light having passed through the fly-eye lens is radiated so that the interference fringes are oblique to the panel 200 as a result, the components of the optical system may be arranged in front and behind thereof.

What is claimed is:

1. A laser annealing device comprising:
a light source that generates laser light;
a fly-eye lens that makes an intensity distribution of the laser light uniform;
a projection mask that masks the laser light having passed through the fly-eye lens; and
a projection lens that forms a laser beam that irradiates a predetermined range of a substrate with the laser light having passed through the projection mask,
wherein an arrangement orientation of the fly-eye lens is rotated by a predetermined angle with respect to an arrangement of a mask pattern of the projection mask to reduce moire that may be generated by interference fringes generated when the laser light passes through the projection mask passing through the fly-eye lens.

2. The laser annealing device according to claim 1, wherein the projection lens is a microlens array in which microlenses that project to at least one opening of the projection mask are arranged one-dimensionally or two-dimensionally.

3. The laser annealing device according to claim 1, wherein the fly-eye lens has a rectangular outer shape and is formed so that the arrangement orientation of the fly-eye lens is inclined by a predetermined angle with respect to one side of the rectangular outer shape.

4. The laser annealing device according to claim 2, wherein the fly-eye lens has a rectangular outer shape and is formed so that the arrangement orientation of the fly-eye lens is inclined by a predetermined angle with respect to one side of the rectangular outer shape.

5. A laser annealing method using a laser annealing device, comprising:
an irradiation step of emitting laser light from a light source that generates the laser light;
a uniformizing step of forming an intensity distribution of the laser light uniform by a fly-eye lens;
a masking step of masking the laser light having passed through the fly-eye lens with a projection mask; and
a forming step of forming a laser beam that irradiates a predetermined area of a substrate with the laser light masked by a projection mask through a projection lens,
wherein the laser annealing device is configured so that an arrangement of the fly-eye lens is rotated by a predetermined angle with respect to an arrangement orientation of a mask pattern of the projection mask to reduce moire that may be generated by interference fringes generated when the laser light passes through the projection mask passing through the fly-eye lens.
